(19) United States
(12) Patent Application Publication
(10) Pub. No.: US 2010/0103556 A1
(43) Pub. Date: Apr. 29, 2010

(54) STORAGE DEVICE

(75) Inventors: Yoshitaka Suzuki, Kawasaki (JP); Takahiro Imamura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/561,810

(22) Filed: Sep. 17, 2009

(30) Foreign Application Priority Data
Oct. 29, 2008 (JP) 2008-278275

(51) Int. Cl. G11B 33/14

(52) U.S. Cl. 360/97.02; G9B/33.035

(57) ABSTRACT

According to one embodiment, a storage device includes a storage medium, a head slider, and a heating element. The storage medium has a lubricating film on the surface. The head slider faces a surface of the storage medium on the medium facing surface. The heating element is embedded in the head slider, and applies heat to the lubricating film from the medium facing surface.

### CROSS-REFERENCE TO RELATED APPLICATIONS

This application is based upon and claims the benefit of priority from Japanese Patent Application No. 2008-278275, filed on Oct. 29, 2008, the entire contents of which are incorporated herein by reference.

### BACKGROUND

1. Field

One embodiment of the invention relates to a storage device comprising a storage medium having a lubricating film on a surface thereof.

2. Description of the Related Art

A magnetic disk in a hard disk drive (HDD) is provided with, for example, a protective film on the recording magnetic film. A hard diamond-like carbon (DLC) film may be used as such a protective film. A lubricating film is applied on the surface of the protective film. A perfluoropolyether (PFPE) film may be used as such a lubricating film. At zero calibration, local thermal expansion occurs in a flying head slider because an electrically heated wire is heated, and thus, a protrusion is formed on the medium facing surface. The protrusion comes into contact with a surface of the magnetic disc. The lubricating film can reduce friction due to contact between the protrusion and the magnetic disc. Reference may be had to, for example, Japanese Patent Application Publication (KOKAI) No. H6-295579, Japanese Patent Application Publication (KOKAI) No. H11-162131, Japanese Patent Application Publication (KOKAI) No. H8-279120, and Japanese Patent Application Publication (KOKAI) No. H10-320735

When zero calibration is performed, the protrusion slides on the surface of the magnetic disk in the down track direction. As a result, a sliding mark is formed on the lubricating film in the down track direction. Because of the sliding mark, the thickness of the lubricating film reduces. At the same time, the lubricating film is pushed toward the sides of the sliding mark because the protrusion slides thereon. Thus, the thickness of the lubricating film increases at the sides of the sliding mark. Therefore, undulations are formed on the surface of the lubricating film. The flying head slider flies along the undulations and thus vibrates. The vibration adversely affects correct writing or reading of magnetic information. Moreover, because of the sliding mark, friction reduction effect of the lubricating film is damaged.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view of an internal configuration of a hard disk drive (HDD) as a storage device according to an embodiment of the invention;

FIG. 2 is an exemplary enlarged perspective view of a flying head slider according to a first embodiment of the invention;

FIG. 3 is an exemplary sectional view taken along line 3-3 in FIG. 2;

FIG. 4 is an exemplary sectional view for explaining how a protrusion is formed in the flying head slider in the first embodiment;

FIG. 5 is an exemplary schematic block diagram of a control system of the storage device in the first embodiment;

FIG. 6 an exemplary graph of outputs of an acoustic emission (AE) sensor in the first embodiment;

FIG. 7 is an exemplary sectional view for explaining how undulations are formed on a surface of a lubricating film in the first embodiment;

FIG. 8 is an exemplary graph of output of the AE sensor in the first embodiment;

FIG. 9 is an exemplary schematic diagram for explaining how heat is applied toward the lubricating film in the first embodiment;

FIG. 10 is an exemplary schematic diagram for explaining how undulations are reduced on the surface of the lubricating film in the first embodiment;

FIG. 11 is an exemplary sectional view of a flying head slider according to a second embodiment of the invention;

FIG. 12 is an exemplary sectional view of a flying head slider according to a third embodiment of the invention; and

FIG. 13 is an exemplary sectional view of a flying head slider according to a fourth embodiment of the invention.

### DETAILED DESCRIPTION

Various embodiments according to the invention will be described hereinafter with reference to the accompanying drawings. In general, according to one embodiment of the invention, a storage device comprises a storage medium, a head slider, and a heating element. The storage medium comprises a lubricating film on the surface. The head slider is configured to face a surface of the storage medium on the medium facing surface. The heating element is embedded in the head slider, and is configured to apply heat to the lubricating film from the medium facing surface.

According to another embodiment of the invention, a storage device comprises a storage medium, a head slider, and an irradiating source. The storage medium comprises a lubricating film on the surface. The head slider is configured to face a surface of the storage medium on the medium facing surface. The irradiating source is embedded in the head slider, and is configured to irradiate the lubricating film with electro-magnetic waves from the medium facing surface to heat the lubricating film.

According to still another embodiment of the invention, a storage device comprises a storage medium, a head slider, and an irradiating source. The storage medium comprises a lubricating film on the surface. The head slider is configured to face a surface of the storage medium on the medium facing surface. The irradiating source is embedded in the head slider, and is configured to irradiate the lubricating film with laser from the medium facing surface to heat the lubricating film at a temperature below a Curie temperature.

According to still another embodiment of the invention, there is provided a film thickness adjusting method comprising adjusting thickness of a lubricating film on a surface of a storage medium to be uniform by applying heat to the lubricating film.

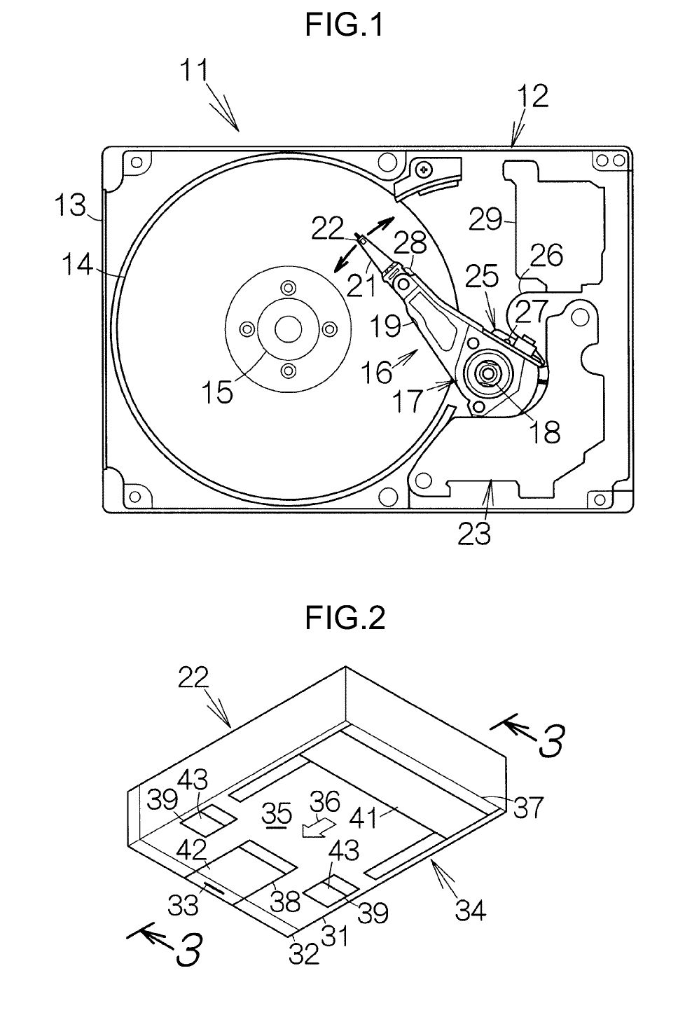

FIG. 1 schematically illustrates an internal configuration of a hard disk drive (HDD) 11 as an example of a storage device according to an embodiment of the invention. The HDD 11 comprises a housing 12. The housing 12 comprises a box-shaped base 13 and a cover (not illustrated). The base 13 defines a flat rectangular parallelepiped internal space, i.e., a housing space. The base 13 may be formed by, for example, casting a metal material such as aluminum (Al). The cover is connected to an opening of the base 13. The housing space is sealed between the cover and the base 13. The cover may be formed by, for example, pressing a piece of plate material.

One or more magnetic disks 14 as storage media are housed in the housing space. The magnetic disks 14 are mounted on a rotating shaft of a spindle motor 15. The spindle motor 15 can rotate the magnetic disks 14 at high speed, such as 5400 rpm, 7200 rpm, or 15000 rpm. The magnetic disks 14 are, for example, perpendicular magnetic recording disks. That is, in a recording magnetic film of each magnetic disk 14, an easy axis of magnetization is vertical, i.e., perpendicular to the surface of the magnetic disk 14.

A carriage 16 is also housed in the housing space. The carriage 16 comprises a carriage block 17. The carriage block 17 is rotatably connected to a spindle 18 that extends vertically. A plurality of carriage arms 19 that horizontally extends from the spindle 18 are defined in the carriage block 17. The carriage block 17 may be formed by, for example, extruding aluminum (Al).

Attached to an end of each of the carriage arms 19 is a head suspension 21. The head suspension 21 extends forward from the end of the carriage arm 19. A flexure is attached to an end of the head suspension 21. In the flexure, a gimbal spring is defined. By the action of the gimbal spring, a posture of a flying head slider 22 can change with respect to the head suspension 21. As will be described later, a head element, i.e., an electromagnetic transducer device, is mounted on the flying head slider 22.

When an air flow is generated on a surface of the magnetic disk 14 by the rotation of the magnetic disk 14, positive pressure, i.e., buoyancy, and negative pressure act on the flying head slider 22 by the action of the air flow. When the buoyancy, the negative pressure, and a pressing force of the head suspension 21 are in balance, the flying head slider 22 can keep floating at relatively high rigidity during the rotation of the magnetic disk 14.

If the carriage 16 rotates about the spindle 18 while the flying head slider 22 is floating, the flying head slider 22 can move along a radius line of the magnetic disk 14. As a result, the electromagnetic transducer device on the flying head slider 22 can traverse a data zone between the innermost recording track and the outermost recording track. Thus, the electromagnetic transducer device on the flying head slider 22 is positioned on a desired recording track.

The carriage block 17 is connected to a power source such as a voice coil motor (VCM) 23. The carriage block 17 can rotate about the spindle 18 by the action of the VCM 23. The swinging of the carriage arm 19 and the head suspension 21 can be realized by the rotation of the carriage block 17.

As clearly illustrated in FIG. 1, a flexible printed wiring board unit 25 is arranged on the carriage block 17. The flexible printed wiring board unit 25 comprises a head integrated circuit (IC) 27 mounted on the flexible printed wiring board 26. The head IC 27 is connected to a reading and a writing elements of the electromagnetic transducer device. A flexure 28 is used for connecting the head IC 27 thereto. The flexure 28 is connected to the flexible printed wiring board unit 25. When magnetic information, i.e., binary information is read, a sense current is provided to the reading element of the electromagnetic transducer device from the head IC 27. Similarly, when binary information is written, a write current is provided to the writing element of the electromagnetic transducer device from the head IC 27. A current value of the sense current is set to be a predetermined value. An electric current is supplied to the head IC 27 from a small circuit board 29 disposed in the housing space and from a print circuit board (not illustrated) mounted on the back side of a basal plate of the base 13.

FIG. 2 is a diagram of the flying head slider 22 according to a first embodiment of the invention. The flying head slider 22 comprises a slider main body 31 having, for example, a flat rectangular parallelepiped shape. An insulated nonmagnetic film, i.e., an element containing film 32 is laminated on an air discharge surface of the slider main body 31. An electromagnetic transducer device 33 is embedded in the element containing film 32. The slider main body 31 may be formed from hard nonmagnetic material such as Al2O3-TiC (AlTiC). The element containing film 32 may be formed from relatively soft insulated nonmagnetic material such as Al2O3 (alumina).

A medium facing surface, i.e., a flying surface 34 of the flying head slider 22, faces the magnetic disk 14. A flat base surface 35 that is a reference surface is defined on the flying surface 34. When the magnetic disk 14 rotates, an air flow 36 is applied to the flying surface 34 from the front end to the rear end of the slider main body 31.

A front rail 37 is formed on the flying surface 34 to rise from the base surface 35 on an upstream side that is an air incoming side of the air flow 36. The front rail 37 extends along an air incoming end of the base surface 35 in a slider width direction. Similarly, a rear center rail 38 is formed on the flying surface 34 to rise from the base surface 35 on a downstream side that is an air exit side of the air flow 36. The rear center rail 38 is disposed in the center of the slider width direction. The rear center rail 38 extends from the slider main body 31 to the element containing film 32.

A pair of rear side rails 39 and 39 is further formed on the flying surface 34 to rise from the base surface 35 on the air exit side. The rear side rails 39 and 39 are disposed on the base surface 35 along left and right edges thereof, respectively. Thus, the rear side rails 39 and 39 are disposed to be spaced at a predetermined distance in the slider width direction. The rear center rail 38 is disposed between the rear side rails 39 and 39.

Air bearing surfaces (ABS) 41, 42, and 43 are defined on top surfaces of the front rail 37, the rear center rail 38, and the rear side rails 39, respectively. Air incoming ends of the air bearing surfaces 41, 42, and 43 are connected to the top surfaces of the rails 37, 38, and 39, respectively, so that gaps are formed between them. When the magnetic disk 14 rotates, the air flow 36 is generated. The flying surface 34 receives the air flow 36. Then, due to the gaps, a relatively large positive pressure that is an ascending force is generated on the air bearing surfaces 41, 42, and 43. Moreover, a large negative pressure is generated on a rear side that is a back side of the front rail 37. Due to balance between the ascending force and the negative pressure, a floating position of the flying head slider 22 is determined. The configuration of the flying head slider 22 is not limited to the above.

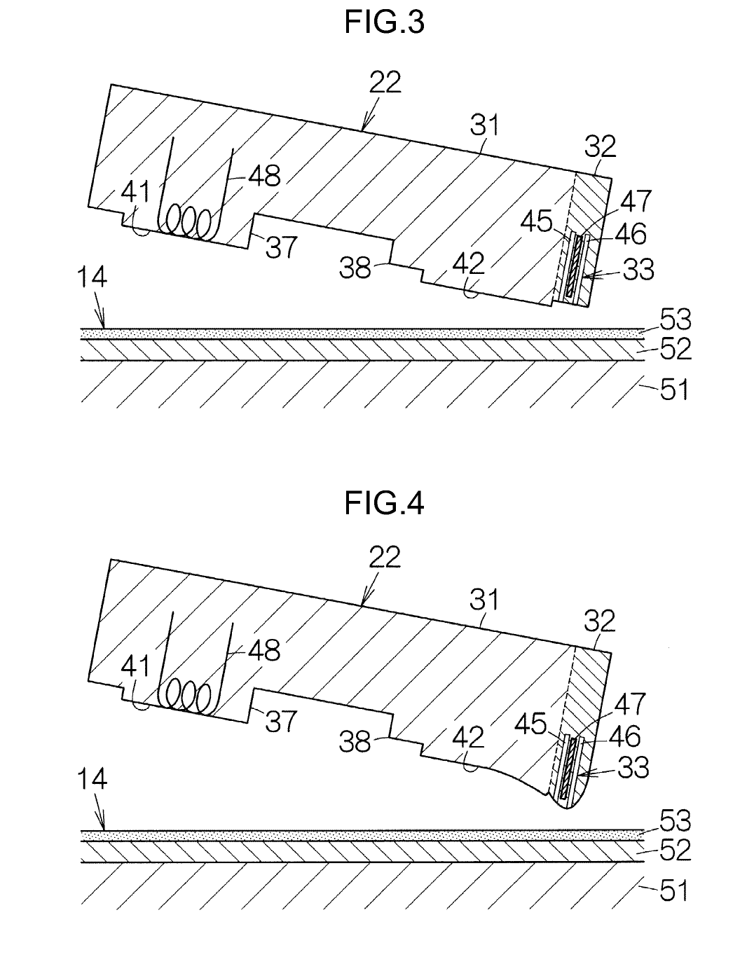

The electromagnetic transducer device 33 is embedded in the rear center rail 38 on the air exit side of the air bearing surface 42. As illustrated in FIG. 3, the electromagnetic transducer device 33 comprises a reading element 45 and a writing element 46. An actuator that is a heater 47 is embedded between the reading element 45 and the writing element 46. The heater 47 is formed of, for example, an electrically heated wire. When electric power is supplied to the heater 47, the heater 47 generates heat. The heater 47, the reading element 45, the writing element 46, and the element containing film 32 thermally expand due to the heat generated by the heater 47. As a result, the element containing film 32 and the slider main body 31 are raised on the air bearing surface 42 as illustrated in FIG. 4. Thus, a protrusion is formed thereon. The reading element 45 and the writing element 46 are moved toward the magnetic disk 14.

On the other hand, as illustrated in FIGS. 3 and 4, a heating element 48 is embedded in the front rail 37 at the air bearing surface 41. The heating element 48 is formed of, for example, a coil. When electric power is supplied to the heating element 48, the heating element 48 generates heat. While the flying head slider 22 floats, the heat generated by the heating element 48 is applied from the air bearing surface 41 of the flying head slider 22 to the magnetic disk 14. The surface of the magnetic disk 14 is heated so that the temperature thereof reaches, for example, about 100 degree centigrade, according to setting of a calorific power of the heating element 48.

The magnetic disk 14 comprises a recording magnetic film 51. A plurality of recording tracks is provided in the recording magnetic film 51 in a down track direction. In the recording magnetic film 51, an easy axis of magnetization is vertical, i.e., perpendicular to the surface of the magnetic disk 14. As a result, the direction of magnetization is set upward or downward vertically, i.e., perpendicularly to the surface of the magnetic disk 14. Thus, binary information is recorded in the recording magnetic film 51. A surface of the recording magnetic film 51 is covered with a protective film 52 such as a diamond-like carbon (DLC) film and a lubricating film 53 such as a perfluoropolyether (PFPE) film. For example, Fomblin Zdol 2000 is used for the lubricating film 53. The magnetic disk 14 may be formed of, for example, a bit patterned medium or a discrete track medium.

For example, a magnetic tunneling junction resistance effect (TuMR) element is used for the reading element 45. In the magnetic tunneling junction resistance effect element, a resistance of a tunnel junction film fluctuates according to a direction of a magnetic field from the magnetic disk 14. Due to the fluctuation of the resistance, binary information can be read from the magnetic disk 14. For example, a single-pole head is used for the writing element 46. Such a single-pole head generates a recording magnetic field due to a thin film coil pattern. Binary information is written in the magnetic field due to the magnetic field. In the electromagnetic transducer device 33, a reading gap of the reading element and a writing gap of the writing element face a surface of the element containing film 32. A hard protective film may be formed on the surface of the element containing film 32 on the air exit side of the air bearing surface 42. Such a hard protective film covers the reading gap and the writing gap that are exposed on the surface of the element containing film 32. For example, a DLS film may be used for the protective film.

As illustrated in FIG. 5, a preamplifier circuit 55, a current supply circuit 56, and a power supply circuit 57 are embedded in the head IC 27. The preamplifier circuit 55 is connected to the reading element 45. A sense current is provided from the preamplifier circuit 55 to the reading element 45. A current value of the sense current is maintained at a predetermined value. The current supply circuit 56 is connected to the writing element 46. A write current is provided from the current supply circuit 56 to the writing element 46. According to the write current provided therefrom, a magnetic field is generated in the writing element 46. The power supply circuit 57 is connected to the heater 47 and to the heating element 48. The power supply circuit 57 supplies a predetermined amount of electric power to the heater 47 and to the heating element 48. When power is provided thereto, the heater 47 and the heating element 48 generate heat. Temperatures of the heater 47 and the heating element 48 are determined according to an electric energy.

A control circuit (hard disk controller) 58 is connected to the head IC 27. The control circuit 58 instructs the head IC 27 to provide a sense current, a write current, and power. At the same time, the control circuit 58 detects the voltage of the sense current. Before detecting the voltage of the sense current, the preamplifier circuit 55 amplifies the voltage of thereof. The control circuit 58 determines binary information according to an output of the preamplifier circuit 55. At the same time, the control circuit 58 detects a “fluctuation” of the voltage value according to an output of the preamplifier circuit 55. For example, if the protrusion comes into contact with the magnetic disk 14, the flying head slider 22 slightly vibrates. Thus, a “fluctuation” occurs in the voltage of a sense current. Such a “fluctuation” is detected by the control circuit 58. At the same time, the control circuit 58 is connected to an acoustic emission (AE) sensor 59. The AE sensor 59 detects vibration of the flying head slider 22 based on contact between the protrusion and the magnetic disk 14.

The control circuit 58 controls operations performed by the preamplifier circuit 55, the current supply circuit 56, and the power supply circuit 57 according to a predetermined software program. The software program may be stored in, for example, a memory 61. According to the software program, zero calibration and an adjusting process of the film thickness of the lubricating film 53 that are described later are performed. Data required for the performance may be stored similarly in the memory 61. The software programs and the data may be transferred to the memory 61 from other storage media. The control circuit 58 and the memory 61 are mounted on, for example, the circuit board 29. The AE sensor 59 is mounted on, for example, the carriage block 17.

Before reading and writing of binary data, a protruding amount of the writing element 46 is set in the HDD 11. When the protruding amount is set, zero calibration is performed. In the zero calibration, a protruding amount of the protrusion is measured when the protrusion comes into contact with the magnetic disk 14. A protruding amount of the protrusion when reading or writing is performed is set according to the protruding amount when the protrusion comes into contact with the magnetic disk 14. A protruding amount of the protrusion is thus set when reading or writing is performed. Then, the electromagnetic transducer device 33, i.e., the writing element 46, can float over the surface of the magnetic disk 14 at a predetermined floating height. Such zero calibration may be performed every time when the HDD 11 is activated.

When zero calibration is performed, the control circuit 58 executes a predetermined software program. When the software program is executed thereby, the control circuit 58 performs initial setting of the HDD 11. At the initial setting, the control circuit 58 instructs the spindle motor 15 to start rotating. Then, the magnetic disk 14 rotates at a predetermined rotation speed. At the same time, the control circuit 58 instructs the VCM 23 to start rotating. Then, the carriage 16 swings around the spindle 18. As a result, the flying head slider 22 faces the surface of the magnetic disk 14. The flying head slider 22 floats over the magnetic disk 14 at a predetermined floating height. The control circuit 58 applies an electric current to the head IC 27. The control circuit 58 monitors an output of the preamplifier circuit 55. That is, the control circuit 58 observes a voltage value of the sense current. Then, the power supply circuit 57 suspends power supply.

When the initial setting is completed, the control circuit 58 supplies a command signal to the power supply circuit 57. The control circuit 58 increments a protruding amount of the protrusion at a predetermined increment. When the command signal is received, the power supply circuit 57 supplies electric power to the heater 47 so that an electric energy is appropriate for the protruding amount after being incremented. The electric energy may be set in advance according to, for example, a coefficient of linear expansion of the writing element 46. Thus, a protruding amount of the protrusion is incremented, and then, the control circuit 58 determines “contact” between the protrusion and the magnetic disk 14. For determining the “contact”, the control circuit 58 observes whether a “fluctuation” appears in a voltage value of the sense current. Thus, the control circuit 58 increments a protruding amount of the protrusion at the predetermined increment until the “fluctuation” is observed. As a result, the protrusion comes into contact with the magnetic disk 14. Thus, the “fluctuation” is observed. Then, the control circuit 58 determines the contact between the protrusion and the magnetic disk 14. The control circuit 58 determines a protruding amount of the protrusion at the time when the protrusion comes into contact with the magnetic disk 14. The determined protruding amount is stored in, for example, the memory 61. Thus, zero calibration is completed.

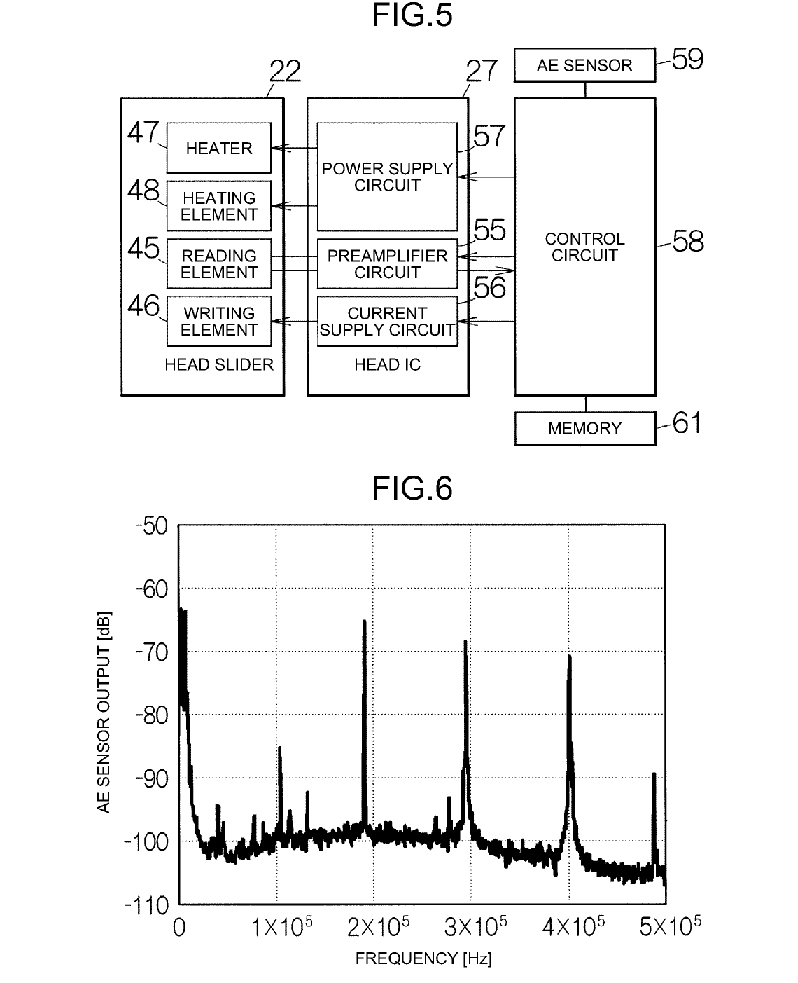

A film thickness adjusting method for the lubricating film 53 is described below. Before the HDD 11 is shipped from a factory, an output of the AE sensor 59 is measured when the protrusion and the magnetic disk 14 contact each other. Before the magnetic disk 14 is shipped from a factory, the lubricating film 53 has a uniform film thickness of a predetermined defined value all over the surface of the magnetic disk 14. The protrusion comes into contact with the surface of the magnetic disk 14 that rotates at a predetermined rotation speed. The rotation speed is set to be, for example, 5400 rpm. As illustrated in FIG. 6, a predetermined output from the AE sensor 59 is detected. Then, an average value of the output for, for example, seven rounds of the magnetic disk 14 in the down track direction is measured. On the surface of the protective film 52, the lubricating film 53 is divided into a bond layer that is a lower layer and a mobile layer that is an upper layer. The bond layer comprises bond molecules that stick to the surface of the protective film 52. The mobile layer comprises mobile molecules that are fluidized on the surface of the bond layer. In the output of the AE sensor 59, a plurality of big peaks is detected with some of the mobile molecules sticking to the protrusion. The output is stored in the memory 61 as a reference value.

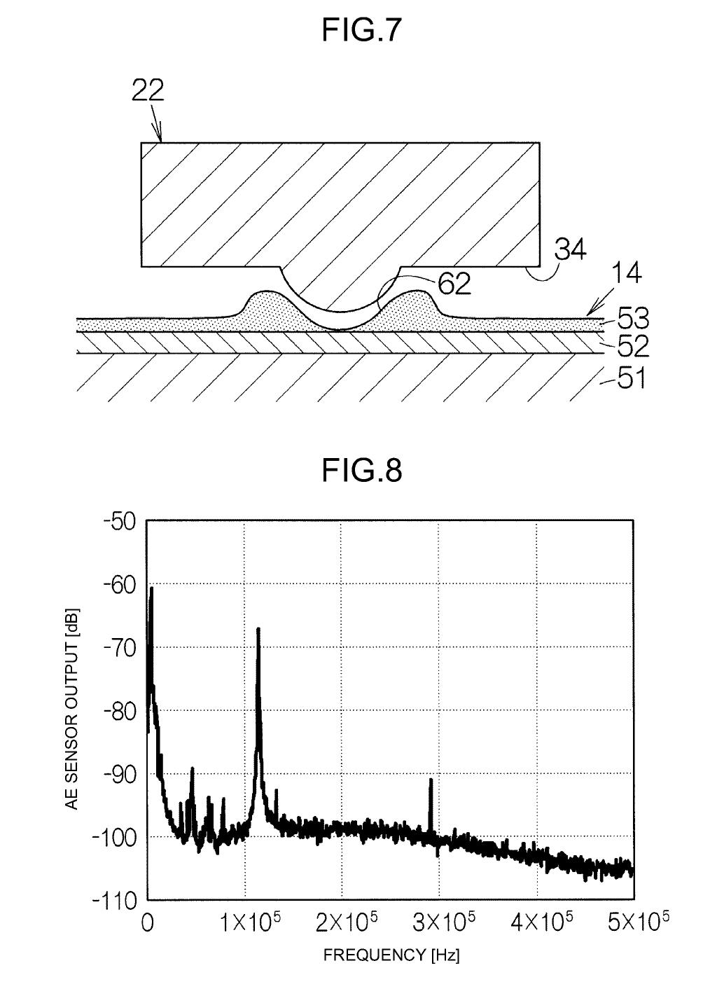

When the zero calibration is performed, the protrusion comes into contact with the surface of the magnetic disk 14. Similarly, also while the flying head slider 22 floats, the protrusion accidentally comes into contact with the surface of the magnetic disk 14. Then, the protrusion slides on the surface of the magnetic disk 14 in the down track direction. The protrusion simultaneously slides, for example, on a plurality of recording tracks. As a result of the sliding, as illustrated in FIG. 7, a sliding mark 62 is formed on the surface of the magnetic disk 14 in the down track direction. Because of the sliding mark 62, the film thickness of the lubricating film 53 is reduced to be smaller than the defined value. Meanwhile, the lubricating film 53 is pushed toward the sides of the sliding mark 62. As a result, on the sides of the sliding mark 62, the film thickness of the lubricating film 53 increases to be larger than the defined value. Thus, undulations are formed on the surface of the lubricating film 53. Thus, the film thickness of the lubricating film 53 is not uniform on the surface of the magnetic disk 14.

When the adjusting process is performed, the control circuit 58 executes a predetermined software program. When the software program is executed thereby, the control circuit 58 instructs the spindle motor 15 to start rotating. Then, the magnetic disk 14 rotates at a predetermined rotation speed. The rotation speed is set to be, for example, 5400 rpm. At the same time, the control circuit 58 instructs the VCM 23 to start rotating. Then, the carriage 16 swings around the spindle 18. As a result, the flying head slider 22 faces the surface of the magnetic disk 14. The flying head slider 22 floats over the magnetic disk 14 at a predetermined floating height. The power supply circuit 57 supplies a predetermined amount of electric power to the heater 47. Thus, the protrusion comes into contact with the surface of the magnetic disk 14. The control circuit 58 monitors an output of the AE sensor 59.

The flying head slider 22 is positioned over the magnetic disk 14 at a predetermined position in the cross track direction. The flying head slider 22 is positioned at, for example, the innermost position of the magnetic disk 14. The protrusion keeps in contact with the magnetic disk 14 for, for example, seven rounds around a rotating shaft of the spindle motor 15. Then, an average of an output of the AE sensor 59 for seven rounds is detected. Then, the flying head slider 22 is positioned at a position closer to a peripheral position from the innermost position. An average of an output of the AE sensor 59 is detected similarly at the peripheral position also. Thus, an average of an output of the AE sensor 59 is detected at every position of the magnetic disk 14 in the cross track direction. The outputs are stored in the memory 61. An average thereof fluctuates according to the film thickness of the lubricating film 53. For example, when the film thickness of the lubricating film 53 is smaller than the defined value, one peak appears as illustrated in FIG. 8. As sticking of the lubricating film 53 is reduced, vibration of the flying head slider 22 is also reduced. As a result, the number of output peaks decreases. For example, when the film thickness of the lubricating film 53 is larger than the defined value, many peaks appear. Thus, an output of the AE sensor 59 fluctuates according to the film thickness of the lubricating film 53.

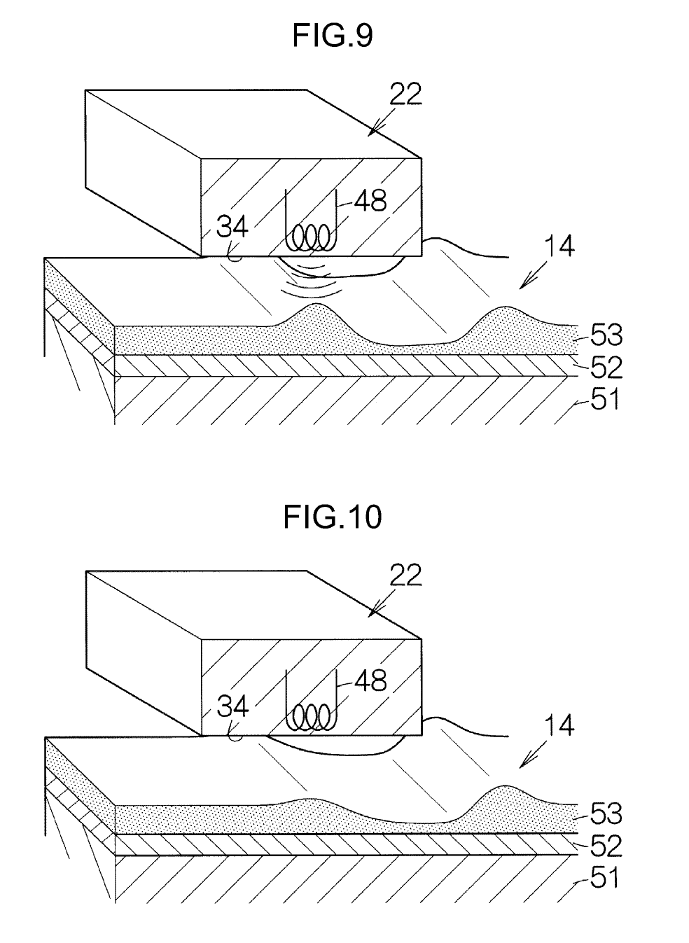

After the output is detected, electric power supply from the power supply circuit 57 to the heater 47 is terminated. A protruding amount of the protrusion is reduced. Then, the control circuit 58 specifies a damaged location in which a film thickness is reduced on the magnetic disk 14 in the cross track direction, according to the outputs stored in the memory 61. The control circuit 58 instructs the VCM 23 to start rotating. Then, the carriage 16 swings around the spindle 18. As a result, as illustrated in FIG. 9, the heating element 48 of the flying head slider 22 faces the surface of the magnetic disk 14 at the side of the damaged location. The flying head slider 22 floats over the magnetic disk 14 at a predetermined floating height.

Then, the power supply circuit 57 supplies a predetermined amount of electric power to the heating element 48. Heat generated by the heating element 48 is applied to the lubricating film 53. As a result, the lubricating film 53 is heated so that the temperature thereof is, for example, about 50 degree centigrade. Thus, the viscosity of the lubricating film 53 is reduced. The diffusion coefficient of the lubricating film 53 increases to be, for example, about as three times as before being heated. The diffusion coefficient indicates an increasing rate of a diffusion area of the lubricating film 53 in a unit time. As a diffusion coefficient is higher, the lubricating film 53 is more easily diffused. As illustrated in FIG. 10, in the lubricating film 53, the lubricating film 53 is moved from a region in which the film thickness thereof is larger to a region in which the film thickness thereof is smaller. As a result, undulations on the surface of the lubricating film 53 are smoothed. The film thickness of the lubricating film 53 is smoothed to be a uniform value. Thus, with the heat generated by the heating element 48, the surface of the lubricating film 53 is smoothed.

When a predetermined time passes after heating process is performed by the heating element 48, the flying head slider 22 is positioned at the damaged location. Then, the power supply circuit 57 supplies a predetermined amount of electric power to the heater 47. Thus, the protrusion comes into contact with the surface of the magnetic disk 14. The control circuit 58 monitors an output of the AE sensor 59. Similarly as above, an average of an output of the AE sensor 59 for seven rounds is detected. The control circuit 58 compares the output thereof thus detected with the reference value. If outputs at all damaged locations are within, for example, a predetermined range including the reference value, the film thickness adjusting process for the lubricating film 53 is completed. On the other hand, if any output at a damaged location is out of the predetermined range including the reference value, the film thickness h adjusting process is again performed at the damaged location. Thus, the surface of the lubricating film 53 is consistently smoothed on the magnetic disk 14. As a result, the film thickness of the lubricating film 53 is consistently maintained to be uniform on the magnetic disk 14. After the film thickness adjusting process is completed, normal writing and reading processes are restarted in the HDD 11. The film thickness adjusting process may be automatically performed at a predetermined interval, or may be irregularly performed according to an instruction from a user of the HDD 11. For example, when the HDD 11 is in a low temperature environment in which the viscosity of the lubricating film 53 further increases, the film thickness adjusting process is particularly effective.

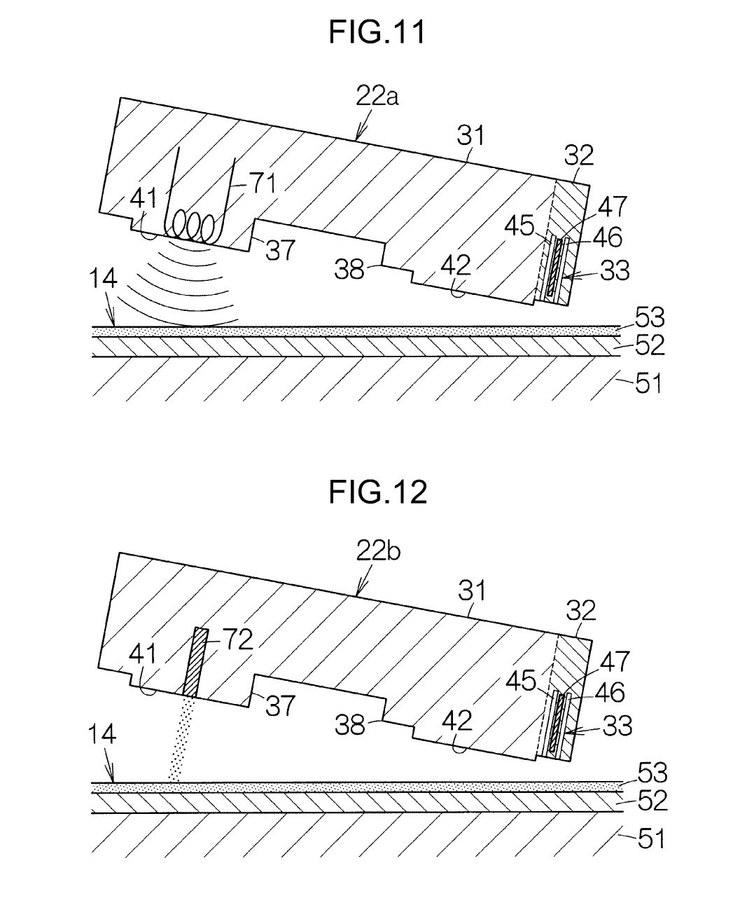

FIG. 11 schematically illustrates a configuration of a flying head slider 22a according to a second embodiment of the invention. In the flying head slider 22a, an irradiating source 71 is embedded in the front rail 37 at the air bearing surface 41, in place of the heating element 48. The irradiating source 71 irradiates the lubricating film 53 with electro-magnetic waves such as microwaves from the flying surface 34. The irradiating source 71 is formed of, for example, a coil or a capacitor. The irradiating source 71 is used in the film thickness adjusting process. The irradiating source 71 irradiates the lubricating film 53 with a microwave at the sides of the damaged location. Thus, the lubricating film 53 is heated. As a result, the lubricating film 53 is moved from a region in which the film thickness thereof is larger to a region in which the film thickness thereof is smaller. Otherwise, the second embodiment is basically similar in configuration to the first embodiment, and like reference numerals refer to corresponding portions. With this configuration, the same effect as described above can be achieved.

FIG. 12 schematically illustrates a configuration of a flying head slider 22b according to a third embodiment of the invention. In the flying head slider 22b, an irradiating source 72 is embedded in the front rail 37 at the air bearing surface 41, in place of the irradiating source 71. The irradiating source 72 irradiates the lubricating film 53 with a laser beam from the flying surface 34. For example, a laser diode (LD) is used for the irradiating source 72. The irradiating source 72 is employed in the film thickness adjusting process. The irradiating source 72 irradiates the lubricating film 53 with a laser beam at the sides of the damaged location. A wave length of the laser beam is set to be in a rage of, for example, 720 nanometers to 1500 nanometers. An output of the laser beam can be thus adjusted, and then, the temperature of the lubricating film 53 at an irradiating point of the laser beam can be set accordingly to be, for example, about 100 degree centigrade that is lower than the Curie temperature. Otherwise, the third embodiment is basically similar in configuration to the first embodiment, and like reference numerals refer to corresponding portions. With this configuration, the same effect as described above can be achieved.

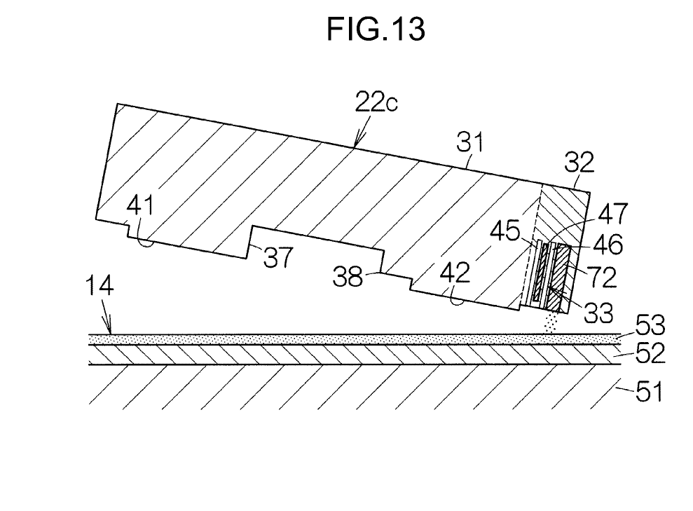

FIG. 13 schematically illustrates a configuration of a flying head slider 22c according to a fourth embodiment of the invention. In the flying head slider 22c, the irradiating source 72 is embedded in the air bearing surface 42 to be adjacent to the electromagnetic transducer device 33. In the irradiating source 72, a wave length of the laser beam is set to be in a rage of, for example, 400 nanometers to 700 nanometers. The control circuit 58 can modify an output of the irradiating source 72. Meanwhile, in the magnetic disk 14, a predetermined composite film is used for the recording magnetic film 51. The composite film is formed of, for example, a cobalt-palladium (Co/Pd) multilayer film and a cobalt-nickel-palladium (CoNi/Pd) multilayer film. Curie temperatures of such composite films are set to be in a range of, for example, 200 degree centigrade to 250 degree centigrade. Otherwise, the fourth embodiment is basically similar in configuration to the first embodiment, and like reference numerals refer to corresponding portions.

In the HDD 11, when binary data is written therein, a thermal assist method is employed. While the flying head slider 22 floats, the irradiating source 72 irradiates recording magnetic film 51 with a laser beam at a predetermined output according to output adjustment. Thus, the recording magnetic film 51 is heated. The temperature of the recording magnetic film 51 increases to the Curie temperature. As a result, in the recording magnetic film 51, a ferromagnet is changed into a paramagnet. In the recording magnetic film 51, the coercitivity thereof is reduced. Then, the wiring element 46 mounted on the electromagnetic transducer device 33 writes binary information in the recording magnetic film 51. When the temperature of the recording magnetic film 51 returns to a room temperature after the writing is completed, the coercitivity of the recording magnetic film 51 increases. In the recording magnetic film 51, the binary data is securely held.

Meanwhile, when the film thickness adjusting process is performed, the irradiating source 72 irradiates the lubricating film 53 with a laser beam at a predetermined output while the flying head slider 22 floats, according to the output adjustment. Thus, the lubricating film 53 is heated. The temperature of the lubricating film 53 increases until the temperature reaches, for example, 100 degree centigrade that is sufficiently lower than the Curie temperature. As a result, the lubricating film 53 is moved from a region in which the film thickness thereof is larger to a region in which the film thickness thereof is smaller. As a result, undulations on the surface of the lubricating film 53 are smoothed. When the film thickness adjusting process is performed, the film thickness of the lubricating film 53 is consistently maintained to be uniform on the magnetic disk 14. Thus, in the flying head slider 22, an output of the irradiating source 72 can be adjusted when binary information is written therein and when the film thickness adjusting process is performed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a storage medium comprising a lubricating film on a surface;
a head slider configured to face a surface of the storage medium on a medium facing surface; and
a heating element embedded in the head slider, the heating element configured to apply heat to the lubricating film from the medium facing surface.

2. The storage device of claim 1, further comprising:
an actuator embedded in the head slider, the actuator configured to form a protrusion of the medium facing surface toward the surface of the storage medium; and
a controller configured to detect reduction of the lubricating film based on contact between the protrusion and the lubricating film.

3. The storage device of claim 2, wherein the controller is configured to cause the heating element to generate heat when detecting reduction of the lubricating film.

4. A storage device comprising:
a storage medium comprising a lubricating film on a surface;
a head slider configured to face a surface of the storage medium on a medium facing surface; and
an irradiating source embedded in the head slider, the irradiating source configured to irradiate the lubricating film with an electro-magnetic wave from the medium facing surface to heat the lubricating film.

5. The storage device of claim 4, further comprising:
an actuator embedded in the head slider, the actuator configured to form a protrusion of the medium facing surface toward the surface of the storage medium; and
a controller configured to detect reduction of the lubricating film based on contact between the protrusion and the lubricating film.

6. The storage device of claim 5, wherein the controller is configured to drive the irradiating source when detecting reduction of the lubricating film.

7. A storage device comprising:
a storage medium comprising a lubricating film on a surface;
a head slider configured to face a surface of the storage medium on a medium facing surface; and
an irradiating source embedded in the head slider, the irradiating source configured to irradiate the lubricating film with laser from the medium facing surface to heat the lubricating film at a temperature below a Curie temperature.

8. The storage device of claim 7, further comprising:
an actuator embedded in the head slider, the actuator configured to form a protrusion of the medium facing surface toward the surface of the storage medium; and
a controller configured to detect reduction of the lubricating film based on contact between the protrusion and the lubricating film.

9. The storage device of claim 8, wherein the controller is configured to drive the irradiating source when detecting reduction of the lubricating film.
